(19) United States
(12) Patent Application Publication
(10) Pub. No.: US 2008/0305354 A1
(43) Pub. Date: Dec. 11, 2008

(54) Filler Composition for Welding onto a Substrate

(76) Inventors: Sheng-Long Lee, Jhongli City (TW); Chih-Horng Chang, Jhongli City (TW); Jing-Chie Lin, Jhongli City (TW); Chin-Kui Lin, Jhongli City (TW); Meng-Syuan Doong, Jhongli City (TW); Kent-Yi Lee, Jhongli City (TW); Yu-Chou Tsai, Jhongli City (TW); Yu-Te Chen, Jhongli City (TW)

Correspondence Address: HDSL, P.O. BOX 220746, CHANTILLY, VA, 20153-0746, US

(21) Appl. No.: 11/839,618

(22) Filed: Aug. 16, 2007

(30) Foreign Application Priority Data
Jun. 6, 2007 (TW) 096120273

(51) Int. Cl. B23K 35/24; B23K 35/02; C22C 21/16

(52) U.S. Cl. 428/576; 420/533

(57) ABSTRACT

A filler composition for welding onto a substrate is composed of 82.5˜96.5 wt %, aluminum, 3.0˜10.0 wt % copper, 0.2˜1.5 wt % magnesium, 0.1˜1.5 wt % silver, 0.1˜2.0 wt % scandium, 0˜1.5 wt % zirconium, and 0˜1.0 wt % titanium, and can be welded with a high success rate to a substrate (such as an aluminum-copper alloy substrate) and avoiding a hot cracking phenomenon and a low welding strength, so as to achieve the effects of enhancing the yield rate and lowering the cost of a product.

### FIELD OF THE INVENTION

The present invention relates to a filler composition, and more particularly to a filler composition consisted of specific elements such as aluminum, copper, magnesium, silver, scandium, zirconium and titanium, such that the advantage of the refined crystal grains of scandium and zirconium elements can enhance the welding effect to improve the copper content to 3.0˜10.0 wt % and the alloy precipitation effect by adding the magnesium and silver elements, so as to overcome the issue of insufficient welding strength at a weld joint of the substrate.

### BACKGROUND OF THE INVENTION

Aluminum-copper alloy is the most popular and earliest aluminum alloy used, and many commercial aluminum alloys including the 2000 series forged aluminum alloy and the 200 series cast aluminum alloy primarily adopting the copper element are developed now. Since aluminum-copper alloy features the advantages of strong ultimate strength (325˜496 MPa), excellent thermal conductivity, high fatigue resistance and good manufacturability, therefore aluminum-copper alloy is applied extensively in many areas such as aviation construction and military weapon, and particularly used as aircraft materials and missile casings.

However, the poor hot cracking resistance of aluminum-copper alloy easily causes hot cracking and defectives in a casting process and incurs a higher manufacturing cost, and thus a welding method is used for overcoming the hot cracking issue of the casting. When aluminum-copper alloy is welded, hot cracking may occur easily or structural changes such as dissolution, re-precipitation, and coarsening of the second-phase particles may cause insufficient strength and elongation of the welding joint, and thus lowering the yield rate.

Hot cracking of aluminum-copper alloy can be divided mainly into two types: a solidification cracking and a heat-affected zone (HAZ) liquidation cracking. The solidification cracking occurs when the bead is almost solidified, and the solute element is diffused and redistributed to cause an exsolution and a CuAl₂ eutectic liquid film with a low melting point. Since the liquid film cannot sustain the contraction and stress produced by the solidification of α-Al, a crack will be formed to cause an intergranular cracking. In the heat-affected zone liquidation (HAZ) cracking, a crack is produced easily during a welding process, since the eutectic phase CuAl₂ having a low melting point and disposed on a grain boundary is melted at the partial melted zone of the substrate by a high temperature to form a liquid and cause the intergranular cracking.

To improve the aforementioned hot cracking issue, many researches in this related field were conducted. In 1960, Borland's generalized theory pointed out that an initial crack produced by the contraction and deformation of small isometric grains is smaller and can be filled effectively, and more grain boundaries can disperse the concentration of diffusions and segregations of solute atoms on the grain boundaries to facilitate reducing the occurrence of hot cracking of the beads (published in Brit. Welding Journal, Volume 7, Number 8, 1996, pages 508-512). The American ASM Handbook also indicated that the heat-affected zone (HAZ) over-precipitation can be retarded by adding a trace of transitional elements to reduce the occurrence of the heat-affected zone (HAZ) intergranular cracking. For instance, the grain stability is improved by adding chromium into a substrate; and the area of the grain boundary is increased by adding refined grains of elements such as zirconium and titanium into the substrate, and thus the eutectic phase centralization can be minimized to reduce the possibility of having a weld cracking (Source: J. R. Davis, “Aluminum and Aluminum alloys”, ASM Specialty Handbook, ASM International, 1994, pp. 376-419). In 2003, Norman disclosed a way of adding a trace of scandium in an aluminum-copper-magnesium alloy (published in Materials Science & Engineering A, 2003, Volume 354A, Pages 188-198), and presumed that the trace of scandium can provide a very good weldability of the alloy, but Norman had not evaluated the actual weldability.

Further, Norman also changed the welding parameters to improve the weld cracking of the aluminum-copper alloy (published in Materials Science & Engineering A, 1999, Volume 259A, Pages 53-64), and pointed out that an increase of welding speed can increase the cooling rate and the composition overcooling degree for reducing the dendrite secondary arm spacing, and thus the structure of the welding joint will be in the form of small isometric grains, which is advantageous for filling the cracks when the welding joint is solidified and reducing possibility of having a hot cracking.

Although the aforementioned methods can reduce the weld cracking of aluminum-copper alloy, the following problems still exist:

(1) The addition of transitional elements has changed the composition of the welding substrate alloy, as well as greatly increases the cost.

(2) Special welding method and technique are required, and thus making the actual operation very inconvenient.

(3) The strength of welding joint cannot meet the standard requirements, and thus its application still has concerns.

Therefore, developing an aluminum-copper alloy and a welding technique to overcome the aforementioned shortcomings becomes an important subject for manufacturers.

### SUMMARY OF THE INVENTION

In view of the foregoing shortcomings of the prior art aluminum-copper alloy that has a hot cracking issue and causes issues such high cost, inconvenient use, and insufficient welding strength, the inventor of the present invention based on years of experience in the related industry to conduct extensive researches and experiments, and finally invented a filler composition for welding onto a substrate to overcome the shortcomings of the prior art.

The primary objective of the present invention is to provide a filler composition for welding a substrate (such as aluminum alloy, aluminum-copper alloy, aluminum alloy casting or aluminum alloy forging), and the composition is consisted of: 82.5˜96.5 wt %, aluminum, 3.0˜10.0 wt % copper, 0.2˜1.5 wt % magnesium, 0.1˜1.5 wt % silver, 0.1˜2.0 wt % scandium, 0˜1.5 wt % zirconium, and 0˜1.0 wt % titanium, and this filler composition can prevent the substrate from producing hot cracking and lowering the bead strength, so as to greatly enhance the yield rate and lower the production cost of a product.

Another objective of the present invention is to provide a convenient way of using a filler and preventing a poor welding of a substrate (such as aluminum alloy, aluminum-copper alloy, aluminum alloy casting or aluminum alloy forging), and performing a welding process of an aluminum-copper alloy under the standard TIG welding conditions to achieve a success rate of approximately 100% and greatly improve the bead strength (greater than 378 MPa) without requiring any special welding technique.

Another objective of the present invention is to weld a substrate (such as aluminum alloy, aluminum-copper alloy, aluminum alloy casting or aluminum alloy forging) with a filler at a high success rate of 98%˜100%, and provide a welding yield strength over 378 MPa after going through the heat treatment.

A further objective of the present invention is to develop a filler that can overcome the shortcomings of aluminum alloy casting and apply the filler extensively in other high strength aluminum alloy forgings, such that an aluminum alloy casting factory or a component factory may use the filler in accordance with the present invention.

In summation of the description above, the invention provides a convenient, economic and novel filler composition that can be used in the fields of aerospace, and military and civil aluminum alloy industries, etc.

To make it easier for our examiner to understand the objective of the invention, its structure, innovative features, and performance, we use a preferred embodiment together with the attached drawings for the detailed description of the invention.

### BRIEF DESCRIPTION OF THE DRAWING

FIG. 1 is a schematic view of the positions of a welding substrate sample and a welding joint in accordance with the present invention.

### DETAILED DESCRIPTION OF THE PREFERRED EMBODIMENTS

The present invention relates to a filler composition for welding onto a substrate, and more particularly to a filler composition for welding onto a substrate (such as aluminum alloy, aluminum-copper alloy, aluminum alloy casting, or aluminum alloy forging). Firstly, 82.5˜96.5 wt % aluminum, 3.0˜10.0 wt % copper, 0.2˜1.5 wt % magnesium, 0.1˜1.5 wt % silver, 0.1˜2.0 wt % scandium, 0˜1.5 wt % zirconium, and 0˜1.0 wt % titanium are melted, degassed by dry argon gas for 30˜40 minutes, sat still for 5˜10 minutes, and then poured into a preheated metal mold. Then, the cast welding alloy is put in an air furnace for a homogenized heat treatment for 515° C.×2 hr+525° C.×8 hr, and the material is forged into filler bars with a diameter of 3 mm by a swaging machine (produced by Heinrich Muller Maschinenfabrik GmbH).

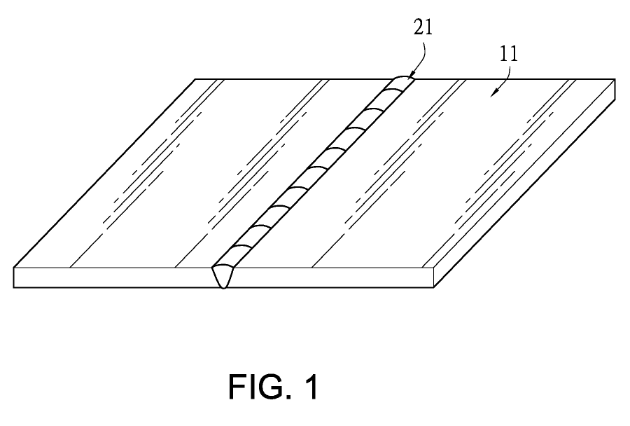

Referring to FIG. 1 for a schematic view of the positions of a welding substrate sample and a welding joint in accordance with the present invention, the welding substrate (such as an aluminum-copper alloy) is manufactured into a welding substrate sample 11 with dimensions of 120 mm×55 mm×5 mm, and then both filler bar and welding substrate sample 11 are cleaned by a 95% alcohol, and finally baked dry by an oven at 110° C. A TIG welding is performed at 12V and 80A at the position of a welding joint 21 as shown in FIG. 1 by a thermal dynamics, thermal arc AC/DC inverter arc welder. The welding substrate sample 11 must be preheated at a temperature over 150° C. to remove the surface moisture before the welding process takes place, so as to prevent forming tiny air bubbles of the welding substrate sample 11 after the welding process. The procedure of the aging treatment of the welding substrate sample 11 is described as follows:

Solid Solution Treatment (conducted in an air furnace for 515° C.×2 hr+525° C.×8 hr)→Water Quenching (at 25° C.)→Artificial Aging (conducted in an oil bath furnace for 185° C.×5 hr). The quench delay time is controlled within 5 seconds. After the welding substrate sample 11 has gone through the thermal treatment, a tensile test is performed by using a universal testing machine and the test results are analyzed. The tensile rate of the sample is 0.3 mm/min.

The first embodiment of the present invention is described as follows:

1. Firstly, a filler A (not shown) is provided, and the composition of filler A consists of 4.5˜7.5 wt % copper, 0.3˜0.7 wt % magnesium, 0.2˜0.6 wt % silver, 0.3˜1.0 wt % scandium, 0.3˜0.7 wt % zirconium, 0˜1.0 wt % titanium, and the composition of aluminum is balanced and adjusted according to the variation of each of the aforementioned compositions.

2. Secondly, a welding substrate sample 11 is provided, and the welding substrate sample 11 of the first embodiment is an A201 alloy with the following basic mechanical properties: a tensile strength of 417.0 MPa, a yield strength of 366.1 MPa and an elongation percentage of 4.6%.

After the welding substrate sample 11 and the filler A have gone through the aforementioned heat treatment and aging treatment and they are welded, the mechanical properties of the welding joint include a tensile strength of 380.3 MPa, a yield strength of 329.6 MPa, and an elongation percentage of 4.3% as shown in Table 1.

The second preferred embodiment of the present invention is described as follows:

1. Firstly, a filler B (not shown) is provided, and the composition of filler B consists of 5.5˜8.0 wt % copper, 0.4˜0.9 wt % magnesium, 0.4˜1.0 wt % silver, 0.3˜1.0 wt % scandium, 0.3˜0.7 wt % zirconium, 0˜1.0 wt % titanium, and the composition of aluminum is balanced and adjusted according to the variation of each of the aforementioned compositions.

2. Secondly, a welding substrate sample 11 is provided, and the welding substrate sample 11 of the second preferred embodiment is an A201 (Al-4.6 Cu—Mg—Ag) alloy with the following basic mechanical properties: a tensile strength 417.0 of MPa, a yield strength of 366.1 MPa and an elongation percentage of 4.6%.

After the welding substrate sample 11 and the filler B have gone through the heat treatment and the aging treatment and they are welded, the mechanical properties of the welding joint include a tensile strength of 413.5 MPa, a yield strength of 342.4 MPa, and an elongation percentage of 4.1% as shown in Table 1.

TABLE 1
Tensile Property of Welding joint of Fillers A, B and Welding
substrate sample 11 (A201 Alloy) after Going through the Aging
Treatment

| | Property | | |
|---|---|---|---|
| | Yield Strength | Tensile Strength | Elongation |
| Filler | (MPa) | (MPa) | Percentage (%) |
| A | 329.6 | 380.3 | 4.3 |
| B | 342.4 | 413.5 | 4.1 |

In the first and second preferred embodiments of the present invention, fillers A, B not only successfully weld a high strength aluminum-copper alloy, but also achieve excellent mechanical properties such as a tensile strength of the welding joint 21 of the welding substrate sample 11 over 90% of the original substrate and an elongation percentage of over 80%. The invention can overcome the hot cracking issue and improve the poor welding property of a high strength aluminum-copper alloy.

In summation of the description above, the filler composition for welding onto a substrate in accordance with the present invention has the advantages of improving the industrial yield rate and lowering the manufacturing cost. Obviously, the invention complies with the patent application requirements and provides a wide range of applications in the fields of aerospace, and military and civil aluminum alloy industries.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A filler composition for welding onto a substrate, and the filler composition consisting of 82.5˜96.5 wt % aluminum, 3.0˜10.0 wt % copper, 0.2˜1.5 wt % magnesium, 0.1˜1.5 wt % silver, 0.1˜2.0 wt % scandium, 0˜1.5 wt % zirconium, and 0˜1.0 wt % titanium.

2. The filler composition for welding onto a substrate as recited in claim 1, wherein the filler is forged into a welding bar by a forging machine.

3. The filler composition for welding onto a substrate as recited in claim 2, wherein the welding bar has a diameter of 3 millimeters (mm).

4. The filler composition for welding onto a substrate as recited in claim 1, wherein the substrate is made of aluminum alloy, aluminum-copper alloy, cast aluminum alloy or forged aluminum alloy.
